(19) United States
(12) Patent Application Publication
(10) Pub. No.: US 2002/0074879 A1
(43) Pub. Date: Jun. 20, 2002

(54) Spindle motor

(75) Inventor: Chang Keun Jun, Shihung (KR)

Correspondence Address: DARBY & DARBY P.C., 805 Third Avenue, New York, NY, 10022, US

(73) Assignee: SAMSUNG ELECTRO-MECHANICS CO., LTD, SUWON-SHI (KR)

(21) Appl. No.: 09/816,544

(22) Filed: Mar. 23, 2001

(30) Foreign Application Priority Data
Dec. 19, 2000 (KR) 2000-78143

(51) Int. Cl. H02K 7/00

(52) U.S. Cl. 310/90; 310/67 R

(57) ABSTRACT

The present invention discloses a spindle motor. The spindle motor of the invention includes: a frame upwardly extruded in a tubular shape at its center portion and having a holder having a core mounted to its outer diameter portion; a metal bearing press-fit to the holder of the frame and having a stepped portion at its outer peripheral surface; a shaft rotatably inserted into the metal bearing and provided with a thrust washer at its lower end portion; a rotor having a magnet coupled to the upper end of the shaft for communicating with the core at the inner diameter surface, and an annular type mounting groove having an engaging portion extruded at the center of the upper end portion at equal intervals; a thrust plate for shielding the lower end portion of the frame into which the metal bearing is press fit; and a stopper of which one end is inserted into the mounting groove of the rotor to be fixed to the engaging portion and of which the other end portion is supported by one side of the frame. Since the shaft and the rotor are firmly supported by a housing, the release of the shaft due to an external impact is prevented, and the span of the bearing can be maximized.

### BACKGROUND OF THE INVENTION

1. Field of the Invention

The present invention relates to a spindle motor, and more particularly, to a spindle motor that prevents parts from being separated by an impact force delivered from the outside and secure the maximum span of a bearing.

2.Description of the Prior Art

Generally, a motor used in a precision apparatus such as a hard disk driver needs the characteristics for precision control as well as a high speed driving force. For example, with the rapid progress of personal computers, the recording density of a hard disk, i.e., recording medium is also increasing rapidly. In addition, in order to improve data access speed, the rotational speed of a motor is increased from 7,200 rpm to 10,000 rpm. Nevertheless, the needs for stability and stillness are also being increased at the same time.

The motor requiring such characteristics is accompanied by a rotary load and the supporting force of a shaft. For this reason, fluid dynamic-pressure bearings having a small driving load, in place of metal bearings or ball bearings in the prior art, are recently being employed as a means for supporting a shaft.

In other words, motors are classified into rolling bearing type motors and sliding bearing type motors according to the supporting type of a driving unit. The rolling bearing type motor is usually adapted to support the shaft by a plurality of ball bearings. This motor has an advantage in that it can be used for a long time because a ball inserted between an inner race and an outer race has a high rigidity.

On the contrary, the rolling bearing type motor has a problem that a high degree of accuracy of rotation cannot be obtained. Thus, although this motor can be adopted for low-speed rotation, it is difficult to adopt it to products requiring high-speed rotation and constant-speed rotation.

In other words, in the case that the rolling bearing type is adopted to a motor of a recording medium requiring high-speed rotation, serious vibration occurs between the gap between a ball and inner and outer races, and resultantly noise occurs.

On the other hand, the sliding bearing type is made to support the shaft by forming a metal bearing containing fluid, or an oil film. Since this type can maintain a high degree of rotation characteristics, it is being widely employed for a hard disk driver, or other motors of a recording medium requiring high-speed rotation.

FIG. 1 is a half sectional view illustrating a spindle motor employing a sliding bearing 110 according to the prior art. As illustrated therein, the motor includes a fixing member having a frame 100, metal bearing 110, and core 120, and a rotating member having a shaft 130, rotor 140, and magnet 150.

The frame 100 is formed integral with a holder 101 upwardly extruded in a tubular shape at its center portion. The metal bearing 110 is inserted and fixed to the inner diameter portion of the holder 101, and the core 120 having a coil rounded to its outer peripheral portion is fixed and mounted to the outer diameter portion thereof.

The center portion of the metal bearing 110 is made hollow in a vertical direction so that the shaft 130 is rotatably inserted thereinto.

In addition, the shaft 130 rotatably inserted into the metal bearing 110 is rotatably coupled to a thrust washer 136 having a disk annular shape at its lower end portion.

The shaft 130 has an annular type ring groove 131 formed at its lower end portion so as to prevent from being released from the metal bearing 110, i.e., the fixing member. At this ring groove 131, an O-ring shaped ring member 135 is insertingly assembled.

In addition, a groove 132 for generating dynamic-pressure is formed at the outer diameter portion of the shaft 130 to thus generate fluid dynamic-pressure in a radial direction.

On the other hand, at the lower end portion of the metal bearing 110 , the inner diameter portion is shielded by a thrust plate 137 to thus be isolated from the outside. At the upper side of the thrust plate 137, the lower end portion of the shaft 130 and the thrust washer 136 are pivotably supported.

Here, the thrust plate 137 supports the shaft 130 and the thrust washer 136 such a manner that the outer peripheral portion of an extension end portion extended in an opened shape is curved and assembled at the lower end of the inner diameter of the holder 101 by cocking or bonding.

In addition, the rotor 140 is coupled integrally to the upper end of the shaft rotatably inserted into the inner diameter portion of the metal bearing 110. This rotor 140 is an upwardly opened cap shape. The magnet 150 is mounted to the outer diameter surface of the extension end portion so that it is opposed to the outer diameter surface of the core 120. A blade 141 for blowing action is formed on the outer diameter surface of the extension end portion.

Under such a structure, an oil gap is formed between the inner diameter surface of the metal bearing 110 and the shaft 130 and thrust washer 136. This oil gap is filled with oil having a predetermined viscosity.

As the oil in the oil gap is concentrated on a dynamic-pressure generating groove 132 side of the metal bearing 110 and the thrust washer 136 side, the oil gap is maintained constant, whereby the shaft 130 is made to be stably driven.

In the thusly constituted spindle motor in the prior art, when power is applied from the outside to the core 120, the rotor to which the magnet 150 is attached is rotated by the mutual electromagnetic force between the core 120 and the magnet 150, whereby the shaft coupled with the rotor 140 is rotated simultaneously.

However, the conventional spindle motor has a disadvantage that although it is prevented from being released by inserting the O-ring shaped ring member 135 into the lower end portion of the shaft 130, the span of the metal bearing 110, i.e., the effective contact portion with the shaft 130 is reduced in order to maximize the thickness and allowance of the ring member 135.

Therefore, in order to guarantee stable driving characteristics of the spindle motor, the span of the bearing, I.e., the effective contact portion with the shaft 130, must be maximized. To realize this in the conventional spindle motor, the entire size of the spindle motor has to be increased inevitably.

Thus, in the conventional spindle motor, there occurs a problem that it is difficult to manufacture a small-sized spindle motor, and the driving characteristics of the spindle motor are made defective upon manufacturing of the small-sized spindle motor.

In addition, the ring member 135 for preventing the shaft 130 and the rotor 140 from being released must be fixed to the shaft 130 by using a specific tool. When the thrust plate 137 is fixed to the frame 100, the frame may be bent or broken upon press fit, and defective insertion or defective fixed-position of a bond may occur.

### SUMMARY OF THE INVENTION

It is, therefore, an object of the present invention to provide a spindle motor which is capable of maximizing the span of a metal bearing and guarantee stable driving characteristics.

It is another object of the present invention to provide a spindle motor which is capable of improving the durability of a product by preventing a rotating body including a shaft from being released due to an external impact force on the motor.

To achieve the above object, there is provided a spindle motor according to the present invention, which includes: a frame upwardly extruded in a tubular shape at its center portion and having a holder having a core mounted to its outer diameter portion; a metal bearing press-fit to the holder of the frame and having a stepped portion at its outer peripheral surface; a shaft rotatably inserted into the metal bearing and provided with a thrust washer at its lower end portion; a rotor having a magnet coupled to the upper end of the shaft for communicating with the core at the inner diameter surface, and an annular type mounting groove having an engaging portion extruded at the center of the upper end portion at equal intervals; a thrust plate for shielding the lower end portion of the frame into which the metal bearing is press fit; and a stopper of which one end is inserted into the mounting groove of the rotor to be fixed to the engaging portion and of which the other end portion is supported by one side of the frame.

The stopper of the present invention includes: a cylindrical body closely contacted and fixed to the inner diameter surface of the holder while covering the outer diameter surface of the metal bearing; and a thin flange unit vertically bent to one end of the body, extended to the outside, passing through the mounting groove, and thus engaged to the engaging portion of the rotor.

The flange unit of the present invention has a plurality of insertion grooves having such a size that the engaging portion can pass through in order to prevent position interference with the engaging portion when the flange unit is inserted into the mounting groove.

The stopper of the present invention includes: a cylindrical body closely contacted and fixed to the inner diameter surface of the holder while covering the outer diameter surface of the metal bearing; and a thin flange unit vertically bent to one end of the body, extended to the outside, and elastically deformed upon contacting the engaging portion of the rotor.

The flange unit of the present invention is molded into rubber having an excellent elastic deformability.

### BRIEF DESCRIPTION OF THE DRAWINGS

FIG. 1 is a cross-sectional view illustrating a spindle motor according to the prior art;

FIG. 2 is a cross-sectional view illustrating a spindle motor according to the present invention;

FIG. 3 is a perspective view illustrating a stopper in the spindle motor according to a first embodiment of the present invention;

FIG. 4 is a sampling perspective view schematically illustrating the assembling state of FIG. 3;

FIG. 5 is a perspective view illustrating a spindle motor according to another embodiment of FIG. 3; and

FIG. 6 is a bottom view illustrating a rotor in the spindle motor according to the present invention.

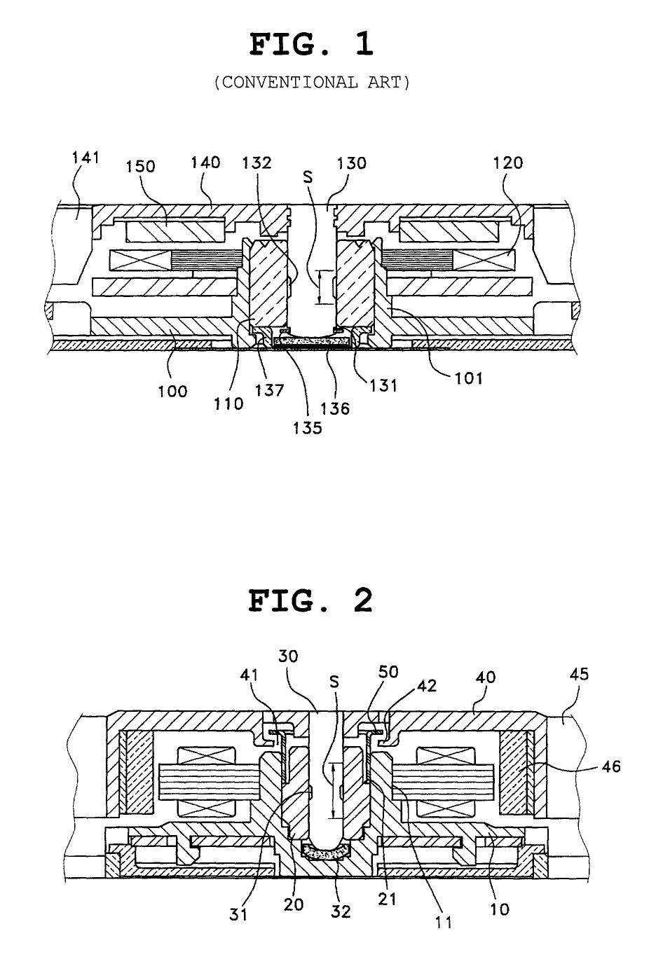

### DETAILED DESCRIPTION OF THE PREFERRED EMBODIMENT

A preferred embodiment of the present invention will now be described with reference to the accompanying drawings.

FIG. 2 is a half sectional view illustrating a spindle motor according to the present invention. As illustrated therein, the spindle motor includes: a fixing member having a frame 10, metal bearing 20, and core, and a rotating member having a shaft 30, rotor 40, and magnet 46.

The frame 10 is formed integral with a holder 11 upwardly extruded in a tubular shape at its center portion, said holder 11 being fixed by having the metal bearing 20 press fit to a vertically hollow shaft opening at its center.

In addition, the core rounded with a coil for applying power to one end of the outer peripheral portion is fixed and mounted at the outer diameter portion of the holder 11. This core is disposed to be opposed to the magnet attached to one side surface of the rotor 40 to be described later for thereby generating a predetermined electromagnet force by communication.

Meanwhile, the metal bearing 20 has a shaft opening formed at its center portion, said shaft opening having a shaft 30, a rotating member, rotatably inserted thereinto, said shaft 30 having a groove 31 for generating dynamic pressure formed at its outer diameter surface for thereby generating a fluid dynamic pressure in a radial direction.

Here, the metal bearing 20 and the shat 30 are spaced at a predetermined interval from each other to thus form an oil gap for filling oil. This oil gap is filled with oil for reducing the mutual friction resistance between the metal bearing and the shaft 30.

On the other hand, the upper end portion of the shaft 30 is coupled to the rotor 40 downwardly extending one end of the outer peripheral side and having a magnet 46 attached to one side thereof. This magnet 46 is disposed to be opposed to the outer diameter surface of the core to thus generate electromagnetic force by communication.

In addition, a structure having driving characteristics of various forms can be formed at the outer peripheral surface of the rotor, i.e., the rotating body. In the present invention, a blade 45 for generating blast is constituted.

And, a board plank type thrust washer 32 for making axial rotation smoothly performed is rotatably coupled integrally with the lower end portion of the shaft 30. The lower end portion of the shaft opening of the frame 10 and metal bearing 20 is shielded from the outside by the thrust plate, or is shielded integrally by the frame 10 as shown in FIG. 2.

The thusly constituted spindle motor is driven in such a manner that, when power is applied from the outside, the rotor 40 is rotated along with the shaft 30 by electromagnetic force generated by communication between the core and the magnet 46.

The above spindle motor has almost the same structure as the conventional spindle motor, except that it has a stopper 50 fixed to the frame 10 in order to prevent the rotor 40 and the shaft 30 from being released due to an impact or vibration applied from the outside.

In other words, FIG. 6 is a bottom view illustrating the bottom of the rotor. The rotor 40 has an annular type mounting groove 41 formed at the upper side of the center, said mounting groove 41 having engaging portions 42 at equal intervals.

In addition, the metal bearing 20 is constructed such that the outer diameter surface of the lower portion is larger than that of the upper portion for thereby forming a stepped portion 21.

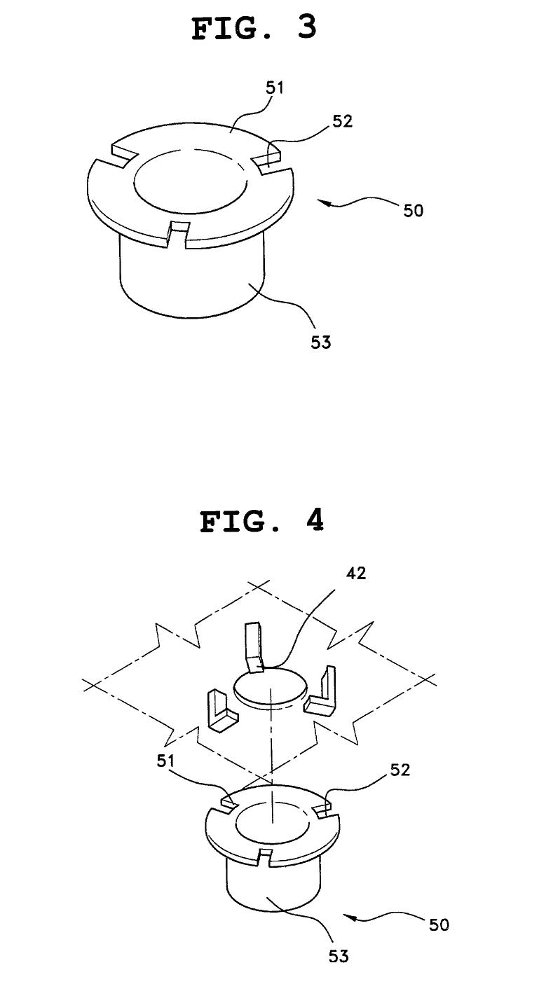

Meanwhile, as illustrated in FIG. 3, the stopper 50 includes a board plank type flange unit 51 engaged to the engaging portions 42; and a cylindrical body 53 of which one end is supported by a stepped portion 21 of the metal bearing 20 to thus closely contacted and fixed to the inner diameter surface of the holder 11.

Here, the flange unit 51 has an insertion groove 52 made hollow to have a predetermined width at a position corresponding to the engaging portions 42 formed at equal intervals at the mounting groove 41.

Such a stopper 50 inserts the flange unit 51 of the stopper 50 into the mounting groove 41 of the rotor 40 as illustrated in FIG. 4.

At this time, the insertion of the stopper 50 is achieved in a state that the engaging portion 42 formed at the insertion groove 52 of the flange unit 51 is opposed to the engaging portion 42 formed at the mounting groove 41 of the rotor 40.

Next, when the flange unit 51 of the stopper 50 is inserted into the mounting groove 41 of the rotor 40, the stopper 50 is rotated in a single direction.

Then, the insertion groove 52 formed at the flange unit 51 of the stopper 50 and the engaging portion 42 of the rotor 40 are crossed with each other, and accordingly the constrained state is maintained, thereby preventing the stopper 50 from being released from the rotor 40.

That is, the insertion groove 52 cut to have a predetermined width is formed at the flange unit 51 of the stopper 50 at equal intervals. This insertion groove 52 is formed at the position corresponding to the engaging portion 42 of the above-mentioned rotor 40.

In this way, when the insertion groove 52 is formed at the flange unit 51, the engaging portion 42 passes through the insertion groove 52 formed at the flange unit 51 upon insertion of the flange unit 51 of the stopper 50 into the mounting groove 41, for thereby preventing mutual position interference. Next, when the stopper 50 is rotated at a predetermined angle in the completely inserted state, the mutual position of the insertion groove 52 of the flange unit 51 and the engaging portion 42 are deviated from each other for thereby making mutual engagement.

Therefore, the stopper 50 can be firmly fixed to the rotor 40 because the circumferential surface of the flange unit 51 is positioned between the upper surface of the rotor 40 and the engaging portion 42 to thereby prevent upward and downward movement.

Said stopper 50 has a diameter enough to fit tightly body 53 into the inner diameter surface of the holder 11 of the frame 10 and cover the outer diameter surface of the metal bearing 20 as shown in FIG. 2.

In other words, the body 53 of said stopper 50 has the outer surface assembled in fit tight into the inner diameter surface of the holder 11 of the frame 10, therefore the body 53 is fixed to said holder 11 firmly.

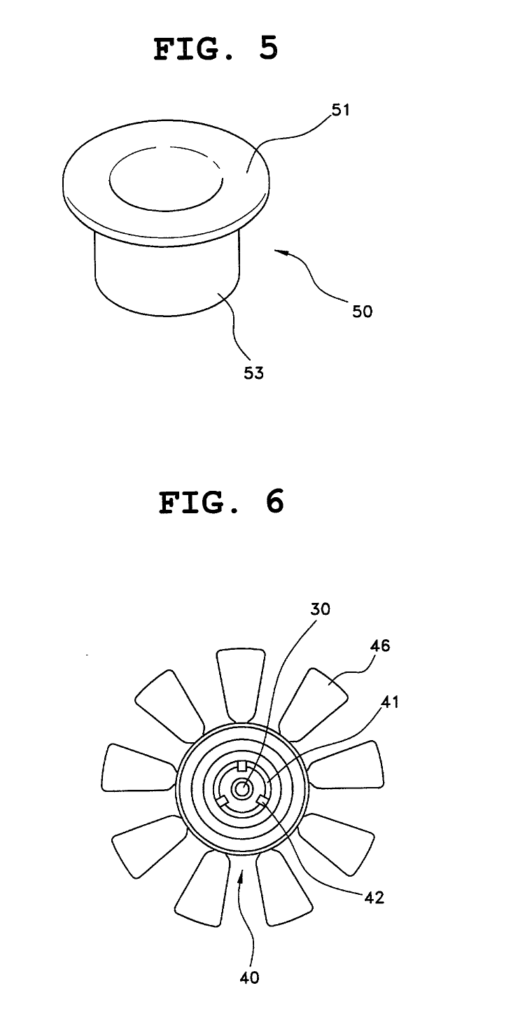

Meanwhile, FIG. 5 is a perspective view illustrating a spindle motor according to another embodiment. As illustrated therein, the stopper 50 can mold the flange unit 51 into a flexible material.

In other words, the stopper 50 includes: a board plank type flange unit 51 engaged to the engaging portion 42 of the rotor 40 and molded into a material having an excellent elastic deformability and stability, and a cylindrical body 53 of which end is supported by a stepped portion 21 of the metal bearing 20 to thus be closely contacted and fixed to the inner diameter portion of the holder 11.

Here, the flange unit 51 can be mold into rubber or synthetic resin having an excellent elastic stability and deformability.

In this way, if the flange unit 51 of the stopper 50 is molded into rubber or synthetic resin, the flange unit 51 is elastically deformed by the contact with the engaging portion 42 formed at the mounting groove 41 at equal intervals when the flange unit 51 of the stopper 50 is inserted into the mounting groove 41 of the rotor 40. On the completion of the assembling, the shape of the flange unit 51 is restored to thus be engaged to the engaging portion 42.

The operation of the spindle motor of the present invention will now be described.

The spindle motor of the present invention is constructed such that it is closely contacted and fit to the inner diameter surface of the holder 11 as the flange of the stopper 50 is engaged to the engaging portion 42 of the rotor 40, and at the same time the lower end portion of the body 53 is supported by the stepped portion 21 formed at the outer diameter surface of the metal bearing 20. The flow of the rotor 40 according to the floating force generated on driving of the motor can be suppressed by the stopper 50.

That is, when power is applied to the core from the outside, the rotor 40 to which the magnet 46 is attached is rotated by the mutual electromagnetic force between the core and the magnet 46, whereby the shaft 30 coupled to the rotor 40 is rotated at the same time.

At this time, the rotor 40 and shaft 30, i.e., the rotating body, generates a predetermined floating force. However, since the flange unit 51 of the stopper 50 coupled to the inner diameter portion of the holder 11 by press fit is engaged to the engaging portion 42 of the rotor 40, the rotor 40 and shaft 30, i.e., the rotating body, can be prevented from being released.

Consequently, since upward and downward movement of the rotor 40 and shaft 30 is suppressed, the span of the metal bearing 20, i.e., the effective contact portion with the shaft 30 can be maximized, resultantly guaranteeing stable driving characteristics of the motor.

Said spindle motor, constituted and operated as before, according to the present invention does not need a ring member for preventing the shaft from being released. Thus, the span of the metal bearing 20, i.e., the effective contact portion with the shaft 30 can be maximized, resultantly guaranteeing stable driving characteristics of the motor.

In addition, even if the impact force applied from the outside during driving of the motor is delivered to the shaft 40 and rotor 30, the stopper supported by the holder 11 of the frame 10 provides firm constraining force for thereby preventing degradation due to the release of the shaft 40 and rotor 30 in advance, and greatly enhancing the reliability of products.

Moreover, the assembling process is so simple that workability and productivity are greatly enhanced.

What is claimed is:

1. A spindle motor, comprising:
a frame upwardly extruded in a tubular shape at its center portion and having a holder having a core mounted to its outer diameter portion;
a metal bearing press-fit to the holder of the frame and having a stepped portion at its outer peripheral surface;
a shaft rotatably inserted into the metal bearing and provided with a thrust washer at its lower end portion;
a rotor having a magnet coupled to the upper end of the shaft for communicating with the core at the inner diameter surface, and an annular type mounting groove having an engaging portion extruded at the center of the upper end portion at equal intervals;
a thrust plate for shielding the lower end portion of the frame into which the metal bearing is press fit; and
a stopper of which one end is inserted into the mounting groove of the rotor to be fixed to the engaging portion and of which the other end portion is supported by one side of the frame.

2. The method according to claim 1, wherein the stopper comprises:
a cylindrical body closely contacted and fixed to the inner diameter surface of the holder while covering the outer diameter surface of the metal bearing; and
a thin flange unit vertically bent to one end of the body, extended to the outside, passing through the mounting groove, and thus engaged to the engaging portion of the rotor.

3. The method according to claim 2, wherein the flange unit has a plurality of insertion grooves having such a size that the engaging portion can pass through in order to prevent position interference with the engaging portion when the flange unit is inserted into the mounting groove.

4. The method according to claim 1, wherein the stopper comprises:
a cylindrical body closely contacted and fixed to the inner diameter surface of the holder while covering the outer diameter surface of the metal bearing; and
a thin flange unit vertically bent to one end of the body, extended to the outside, and elastically deformed upon contacting the engaging portion of the rotor.

5. The method according to claim 4, wherein the flange unit is molded into rubber having an excellent elastic deformability.
